(19) United States
(12) Patent Application Publication
(10) Pub. No.: US 2009/0207200 A1
(43) Pub. Date: Aug. 20, 2009

(54) LIQUID DISCHARGING APPARATUS AND METHOD OF DISCHARGING LIQUID

(75) Inventor: Noboru TAMURA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/388,998

(22) Filed: Feb. 19, 2009

(30) Foreign Application Priority Data
Feb. 20, 2008 (JP) 2008-039334

(51) Int. Cl. B41J 29/38; G06F 3/12

(52) U.S. Cl. 347/9; 358/1.15

(57) ABSTRACT

A liquid discharging apparatus stores data transmitted at each timing of a predetermined period in first storage units for the each timing and discharges liquid droplets from nozzles based on the data stored in the first storage units for the each timing. The liquid discharging apparatus includes the nozzles and the first storage units, which are disposed for the nozzles for storing the data for controlling discharge of the liquid droplets from the nozzles. A second storage unit is used for storing the data transmitted at a timing. A data selecting unit is used for selecting whether to store the data transmitted at another timing after the timing in the first storage unit or to store the data stored in the second storage unit in the first storage unit when the data is stored in the first storage units at the each timing.

### BACKGROUND

1. Technical Field

The present invention relates to a liquid discharging apparatus and a method of discharging liquid.

2. Related Art

As liquid discharging apparatuses that discharge liquid, ink jet printers have been known. The ink jet printers form an image on a medium by discharging liquid droplets toward the medium such as a paper sheet or a cloth so as to form dots on the medium.

When a head is formed ideally, dots can be formed in ideal positions on the medium. However, for example, when the head is formed to be tilted, the dots are formed to be deviated from the ideal positions.

Accordingly, technology for correcting the deviation of the dots by correcting image data by performing an image processing has been proposed.

A related art has been disclosed in JP-A-2004-17464.

When the image data is corrected by performing an image processing, an image processing method is changed in accordance with the deviation of dots. Accordingly, the image processing becomes complicated. As a result, a time for performing the image processing is required.

### SUMMARY

An advantage of some aspects of the invention is that it provides a liquid discharging apparatus and a method of discharging liquid that are capable of correcting the deviation of dots without performing correction of image data in image processing.

According to a major aspect of the invention, there is provided a liquid discharging apparatus that stores data transmitted at each timing of a predetermined period in a plurality of first storage units for the each timing and discharges liquid droplets from a plurality of nozzles based on the data stored in the plurality of first storage units for the each timing. The liquid discharging apparatus includes: the plurality of the nozzles; the plurality of first storage units that is disposed for the plurality of nozzles for storing the data for controlling discharge of the liquid droplets from the plurality of nozzles; a second storage unit that is used for storing the data transmitted at a timing; and a data selecting unit that is used for selecting whether to store the data transmitted at another timing after the timing in the first storage unit or store the data stored in the second storage unit in the first storage unit when the data is stored in the plurality of first storage units at the each timing.

Other aspects of the invention will become apparent by referring to descriptions below and the accompanying drawings.

### BRIEF DESCRIPTION OF THE DRAWINGS

The invention will be described with reference to the accompanying drawings, wherein like numbers reference like elements.

FIG. 1 is a block diagram showing the entire configuration of a printer 1.

FIG. 2A is a schematic diagram showing the entire configuration of the printer 1.

FIG. 2B is a traverse cross-section view of the entire configuration of the printer 1.

FIG. 3 is an explanatory diagram showing the arrangement of nozzles.

FIG. 4 is an explanatory diagram showing the appearance of forming dots.

FIG. 5 is an explanatory diagram of a driving signal COM.

FIG. 6 is a block diagram showing the configuration of a head control unit of a reference example (for a case where pixel data is two-bits).

FIG. 7 is an explanatory diagram of various signals.

FIG. 8 is an explanatory diagram showing the sequence of transmission of pixel data SI.

FIG. 9 is a block diagram showing the configuration of a head control unit of the reference example (for a case where the pixel data is one bit).

FIG. 10A is an explanatory diagram showing the appearance of dot formation for a case where a head is tilted in the reference example.

FIG. 10B is an explanatory diagram showing the appearance of dot formation according to an embodiment of the invention for a case where a head is tilted.

FIG. 11 is a block diagram showing the configuration of a head control unit according to a first embodiment of the invention.

FIG. 12 is an explanatory diagram showing setting of the multiplexer according to the first embodiment.

FIG. 13 is a block diagram showing the configuration of a head control unit according to a second embodiment of the invention.

FIG. 14 is an explanatory diagram showing setting of a multiplexer according to the second embodiment.

FIG. 15 is a block diagram showing the configuration of a head control unit according to a third embodiment of the invention.

FIG. 16 is an explanatory diagram showing settings of a first multiplexer 93 and a second multiplexer 95 according to the third embodiment.

FIG. 17A is an explanatory diagram of a data transfer unit 641 according to the reference example and the first to third embodiments.

FIG. 17B is an explanatory diagram of a data transfer unit according to a fourth embodiment of the invention.

### DESCRIPTION OF EXEMPLARY EMBODIMENTS

At least the followings become apparent by descriptions below and the accompanying drawings.

According to a first aspect of the invention, there is provided a liquid discharging apparatus that stores data transmitted at each timing of a predetermined period in a plurality of first storage units for the each timing and discharges liquid droplets from a plurality of nozzles based on the data stored in the plurality of first storage units for the each timing. The liquid discharging apparatus includes: the plurality of the nozzles; the plurality of first storage units that is disposed for the plurality of nozzles for storing the data for controlling discharge of the liquid droplets from the plurality of nozzles; a second storage unit that is used for storing the data transmitted at a timing; and a data selecting unit that is used for selecting whether to store the data transmitted at another timing after the timing in the first storage unit or store the data stored in the second storage unit in the first storage unit when the data is stored in the plurality of first storage units at the each timing. According to the above-described liquid discharging apparatus, the deviation of dots can be corrected without correcting data by performing image processing in a pre-stage for the data transmitted at a timing of a predetermined period.

In addition, it is preferable that the above-described liquid discharging apparatus further includes a third storage unit that is used for storing the data that is transmitted at another timing prior to the timing, and the data selecting unit selects whether to store the data transmitted at another timing after the timing in the first storage unit, store the data stored in the second storage unit in the first storage unit, or store the data stored in the third storage unit in the first storage unit. In such a case, even when the deviation of the dots is large, correction can be made.

In addition, in the above-described liquid discharging apparatus, it is preferable that the liquid discharging apparatus includes a plurality of the second storage units and a plurality of the data selecting units, the plurality of the second storage units is disposed in correspondence with the plurality of the first storage units, and the plurality of the data selecting units is disposed in correspondence with the plurality of the first storage units. In such a case, the deviation of dots can be corrected not only for the deviation of dots in a case where a plurality of nozzles is tilted but also for the deviation of dots in a case where the dots are deviated to be scattered for each nozzle due to characteristics of the individual nozzles.

In addition, it is preferable that the above-described liquid discharging apparatus further includes: a first data selecting unit that is disposed as the data selecting unit in correspondence with a first nozzle; a second data selecting unit that is disposed as the data selecting unit in correspondence with a second nozzle; and a third data selecting unit that selects either first data that is the data transmitted to the first nozzle or second data that is the data transmitted to the second nozzle to be stored in the second storage unit. In such a case, the plurality of nozzles includes the first nozzle and the second nozzle, when the first data is stored in the second storage unit by the third data selecting unit, the first data selecting unit stores the first data stored in the second storage unit in the first storage unit, and the second data selecting unit stores the data transmitted at another timing after the timing in the first storage unit, and, when the second data is stored in the second storage unit by the third data selecting unit, the first data selecting unit stores the data transmitted at another timing after the timing in the first storage unit, and the second data selecting unit stores the second data stored in the second storage unit in the first storage unit. In such a case, the number of storage units for correcting the deviation of dots can be decreased.

In addition, it is preferable that the above-described liquid discharging apparatus further includes: a main-side controller; a carriage that is used for moving the plurality of nozzles; and a cable that is used for transmitting the data from the main-side controller side to the carriage side. In such a case, the second storage unit and the data selecting unit are disposed on the carriage side. In this case, the deviation of dots can be corrected by using the configuration of the carriage side without changing the configuration of the main body side.

In addition, it is preferable that the above-described liquid discharging apparatus further includes: a main-side controller; a carriage that is used for moving the plurality of nozzles; and a cable that is used for transmitting the data from the main-side controller side to the carriage side. In such a case, the second storage and the data selecting unit are disposed on the main-side controller side. In this case, the deviation of dots can be corrected at a time when the data is transferred to the carriage side through the cable.

According to a second aspect of the invention, there is provided a method of discharging liquid droplets in which data for controlling discharge of liquid droplets from nozzles transmitted at each timing of a predetermined period is stored in a plurality of first storage units that is disposed for the nozzles, and the liquid droplets are discharged from the nozzles at the each timing based on the data stored in the plurality of first storage units. The method includes: storing the data transmitted at a timing in a second storage unit; and selecting whether to store the data transmitted at another timing after the timing in the first storage unit or store the data stored in the second storage unit in the first storage unit when the data is stored in the plurality of first storage units at the each timing. According to the above-described method of discharging liquid, the deviation of dots can be corrected without correcting data by performing image processing in a pre-stage for the data transmitted at a timing of a predetermined period.

### Configuration of Printer

### Configuration of Ink Jet Printer

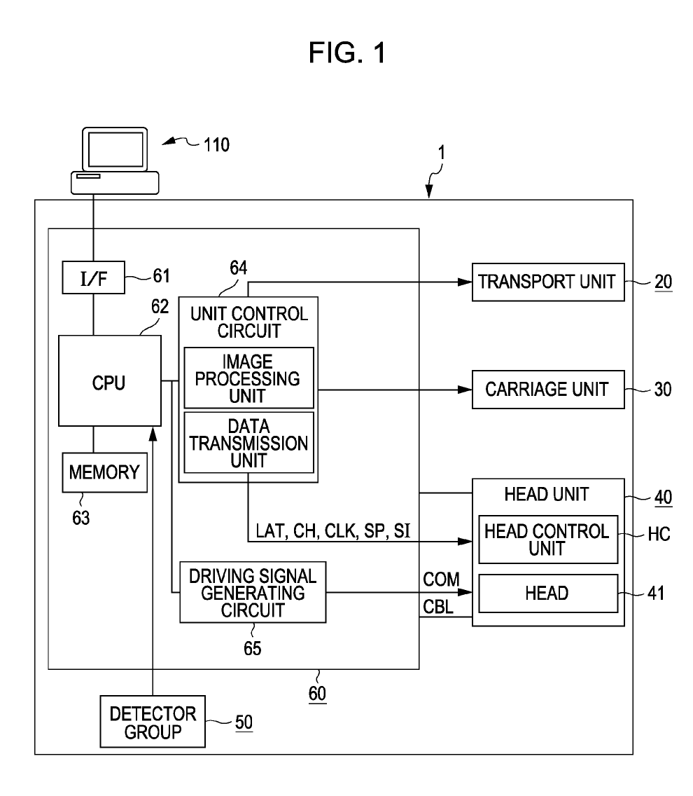

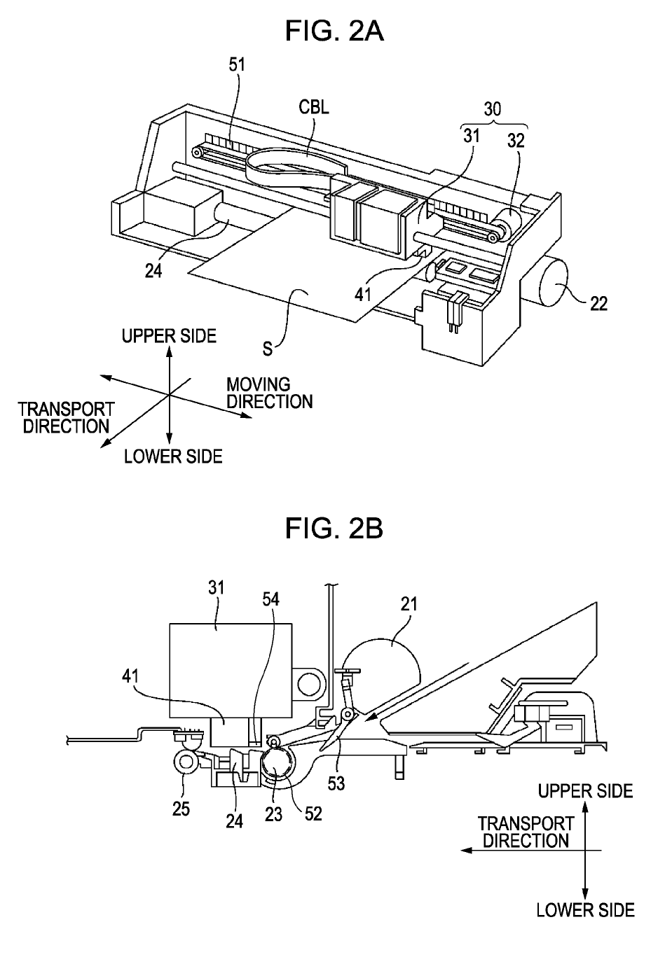

FIG. 1 is a block diagram showing the entire configuration of a printer 1. FIG. 2A is a schematic diagram showing the entire configuration of the printer 1. FIG. 2B is a traverse cross-section view of the entire configuration of the printer 1. Hereinafter, a basic configuration of the printer will be described.

The printer 1 includes a transport unit 20, a carriage unit 30, a head unit 40, a detector group 50, and a main body-side controller 60. The printer 1 that receives print data from a computer 110 as an external device controls the above-described units (the transport unit 20, the carriage unit 30, and the head unit 40) by using the main body-side controller 60. The main body-side controller 60 prints an image on a paper sheet by controlling each unit based on the print data that is received from the computer 110. The state of the printer 1 is monitored by the detector group 50, and the detector group 50 outputs a detection result to the main body-side controller 60. The main body-side controller 60 controls each unit based on the detection result that is output from the detector group 50.

The transport unit 20 is used for transporting a medium (for example, a paper sheet S or the like) in a predetermined direction (hereinafter, referred to as a transport direction). This transport unit 20 includes a paper feed roller 21, a transport motor 22 (also referred to as a PF motor), a transport roller 23, a platen 24, and a paper discharge roller 25. The paper feed roller 21 is a roller that is used for feeding a paper sheet that is inserted into a paper inserting port to the inside of the printer. The transport roller 23 is a roller that is used for transporting the paper sheet S fed by the paper feed roller 21 to a printable area and is driven by a transport motor 22. The platen 24 supports a paper sheet S in the middle of a printing process. The paper discharge roller 25 is a roller that is used for discharging the paper sheet S to the outside of the printer and is disposed on the downstream side of the printable area in the transport direction.

The carriage unit 30 is used for moving (also referred to as scanning) a head in a predetermined direction (hereinafter, referred to as a moving direction). The carriage unit 30 includes a carriage 31 and a carriage motor 32 (also referred to as a CR motor). The carriage 31 can reciprocate in the moving direction and is driven by the carriage motor 32. In addition, the carriage 31 holds an ink cartridge for storing ink so as to be detachably attached thereto.

The head unit 40 is used for discharging ink on a paper sheet. The head unit 40 includes a head 41 that has a plurality of nozzles and a head control unit HC that controls the head 41. This head 41 is disposed in the carriage 31. Thus, when the carriage 31 moves in the moving direction, the head 41 is also moved in the moving direction. Then, by intermittently discharging ink during movement of the head 41 in the moving direction, a dot line (raster line) along the moving direction is formed on a paper sheet.

In addition, between the main body-side controller 60 that is disposed on the main body side of the printer and the head unit 40 that moves together with the carriage 31, a flexible cable CBL is disposed. The transmission and reception of a signal between the main body-side controller 60 and the head unit 40 is performed through the cable CBL.

In the detector group 50, a linear-type encoder 51, a rotary-type encoder 52, a paper detecting sensor 53, an optical sensor 54, and the like are included. The linear-type encoder 51 detects the position of the carriage 31 in the moving direction. The rotary-type encoder 52 detects the amount of rotation of the transport roller 23. The paper detecting sensor 53 detects the front end position of a paper sheet in the middle of a feed process. The optical sensor 54 detects placement of a paper sheet by using a light emitting part and a light receiving part that are mounted to the carriage 31. The optical sensor 54 detects the position of the end part of the paper sheet while moved by the carriage 31, and thereby the optical sensor 54 can detect the width of the paper sheet. In addition, the optical sensor 54 can also detect the front end (an end part on the downstream side in the transport direction and is also referred to as an upper end) and the rear end (an end part on the upstream side in the transport direction and is also referred to as a lower end), depending on the situation.

In addition, the linear-type encoder 51 includes a linear scale in which slits are formed with a constant pitch (for example, 360 dpi) therebetween and a detection part. As the detection part detects the slits, the linear-type encoder 51 detects movement of the carriage in the moving direction by a predetermined distance. A pulse signal of a latch signal LAT to be described later is generated based on a detection signal transmitted from the linear-type encoder 51. Accordingly, when the carriage moves at a constant speed, the pulse signal of the latch signal LAT is generated in a predetermined period.

The main body-side controller 60 is a control unit (control part) for performing a control operation for the printer. The main body-side controller 60 includes an interface unit 61, a CPU 62, a memory 63, and a unit control circuit 64. The interface unit 61 performs an operation for transmitting and receiving data between the computer 110 as an external device and the printer 1. The CPU 62 is an arithmetic processing unit for performing a control operation for the entire printer. A memory 63 is used for acquiring an area for storing a program of the CPU 62, a work area, and the like. The memory 63 has memory elements such as a RAM, an EEPROM, and the like. The CPU 62 controls each unit through the unit control circuit 64 in accordance with the program that is stored in the memory 63.

In the main body-side controller 60, a driving signal generating circuit 65 is disposed. This driving signal generating circuit 65 generates a driving signal COM that is used for driving the head 41. The driving signal COM that is generated by the driving signal generating circuit 65 is transmitted to the head 41 through the cable CBL. The driving signal COM will be described later.

In a printing process, the main body-side controller 60 prints an image constituted by countless dots on a paper sheet by alternately repeating a dot forming operation for discharging ink from the head 41 in the middle of movement in the moving direction and a transport operation for transporting the paper sheet in the transport direction.

### Nozzle

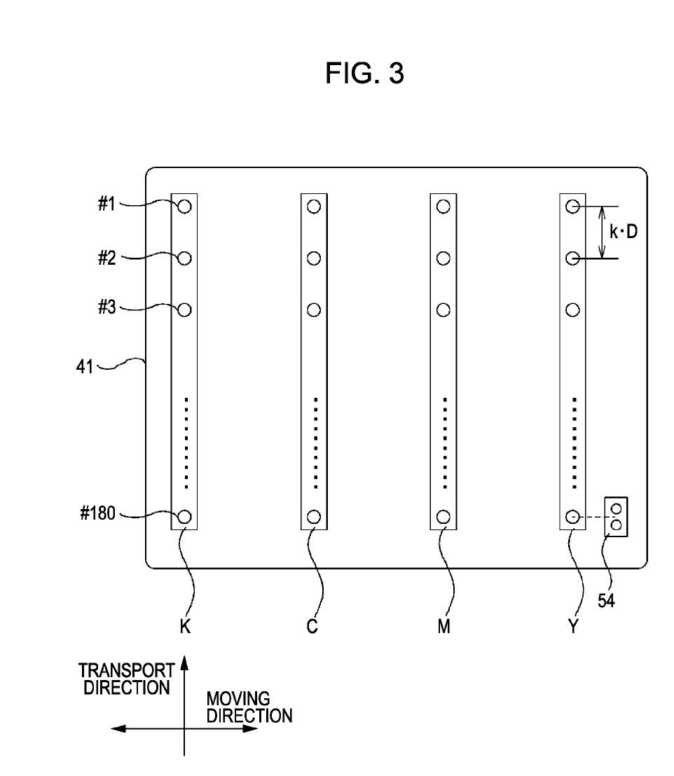

FIG. 3 is an explanatory diagram showing the arrangement of nozzles on a lower face of the head 41. On the lower face of the head 41, a black nozzle row K, a cyan nozzle row C, a magenta nozzle row M, and a yellow nozzle row Y are formed. Each nozzle row includes a plurality of (in this embodiment, 180) nozzles that are discharge openings for discharging ink of a corresponding color.

The plurality of nozzles of each nozzle row is arranged in the transport direction with a constant gap (nozzle pitch: k-D) therebetween. Here, D is a minimum dot pitch (that is, a gap of dots formed on a paper sheet S at the highest resolution) in the transport direction. Here, k is an integer equal to or larger than one. For example, when the nozzle pitch is 180 dpi ( 1/180 inch) and the dot pitch in the transport direction is 360 dpi ( 1/360 inch), k=2.

To a nozzle of each nozzle row, a number corresponding to the number of nozzles located on the downstream side of the nozzle is assigned (#1 to #180). In other words, nozzle#1 is located on the downstream side in the transport direction relative to nozzle#180. In addition, the above-described optical sensor 54 is located in a same position in the transport direction of a paper sheet as that of nozzle#180 that is located on the uppermost stream side.

In each nozzle, an ink chamber (not shown) and a piezo element are disposed. By driving the piezo element, the ink chamber is expanded or contracted, and thereby ink droplets are discharged from the nozzle.

### Reference Example

### Appearance of Dot Formation in Reference Example

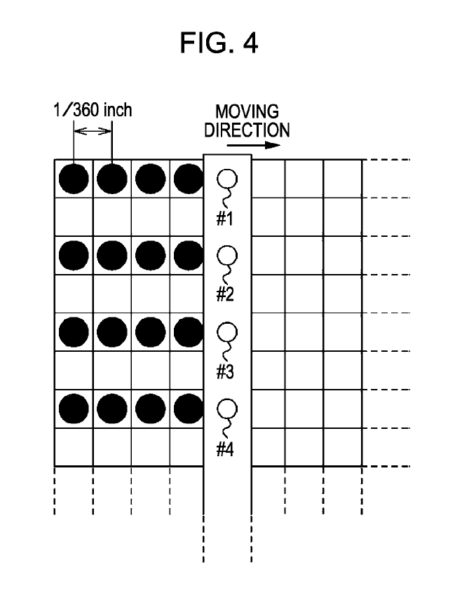

FIG. 4 is an explanatory diagram showing the appearance of forming dots. Here, a case where the dot pitch is 360 dpi will be described. For simplification of description, only the black nozzle row will be described. However, nozzle rows of different colors are operated in an almost same manner as for the black nozzle. Black circles in the figure are dots that are formed on the paper sheet. A square (square of side 1/360 inch) represents one pixel area. As shown in the figure, every time the nozzles move in the moving direction by 1/360 inch, ink is discharged from each nozzle, and thereby dots are formed with a dot pitch of 360 dpi in the moving direction.

In this reference example, as shown in the figure, dots are precisely formed in the pixels.

### Control Method 1 of Reference Example

Next, a control method for performing such dot formation will be described. First, the driving signal COM will be described. Then, the configuration of the head control unit HC will be described, and finally, the operation of the head control unit HC will be described.

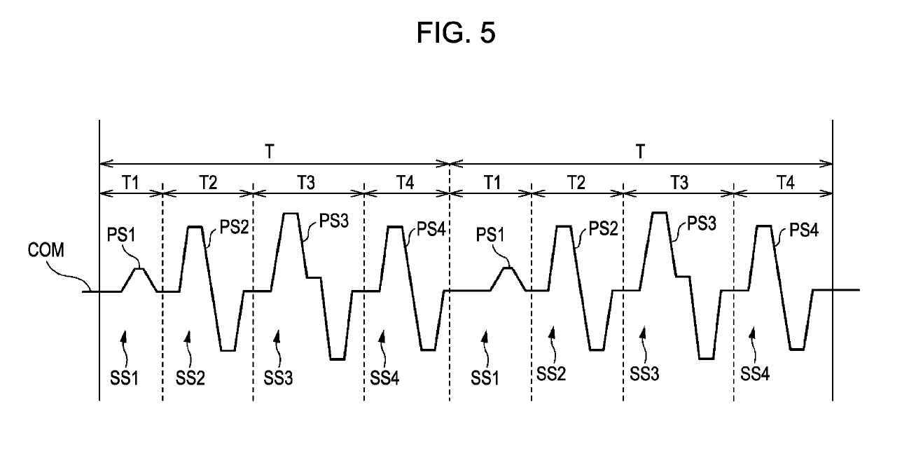

FIG. 5 is an explanatory diagram of the driving signal COM. In the driving signal COM, a same signal is repeated for every period T. This period T is a time required for the carriage to move a distance of 1/360 inch (a distance corresponding to one pixel). In the figure, the driving signal corresponding to two periods is shown.

In the period T, four periods T1 to T4 are included. In the first period T1, a first interval signal SS1 that includes a driving pulse PS1 is generated. In addition, a second interval signal SS2 that includes a driving pulse PS2 is generated in the second period T2, a third interval signal SS3 that includes a driving pulse PS3 is generated in the third period T3, and a fourth interval signal SS4 that includes a driving pulse PS4 is generated in the fourth period T4.

The waveforms of the driving pulses PS1 to PS4 are set based on the operation performed by the piezo element. The driving pulse PS1 is a waveform so as to drive the piezo element such that ink is not discharged from the nozzle. The driving pulse PS3 is a waveform so as to drive the piezo element such that ink droplets of 3 pl are discharged from the nozzle. In addition, the driving pulse PS2 and the driving pulse PS4 are waveforms so as to drive the piezo element such that ink droplets of 7 pl are discharged from the nozzle.

The above-described driving signal COM is repeatedly generated for every period T by the driving signal generating circuit 65 and is transmitted to the head control unit HC through the cable CBL.

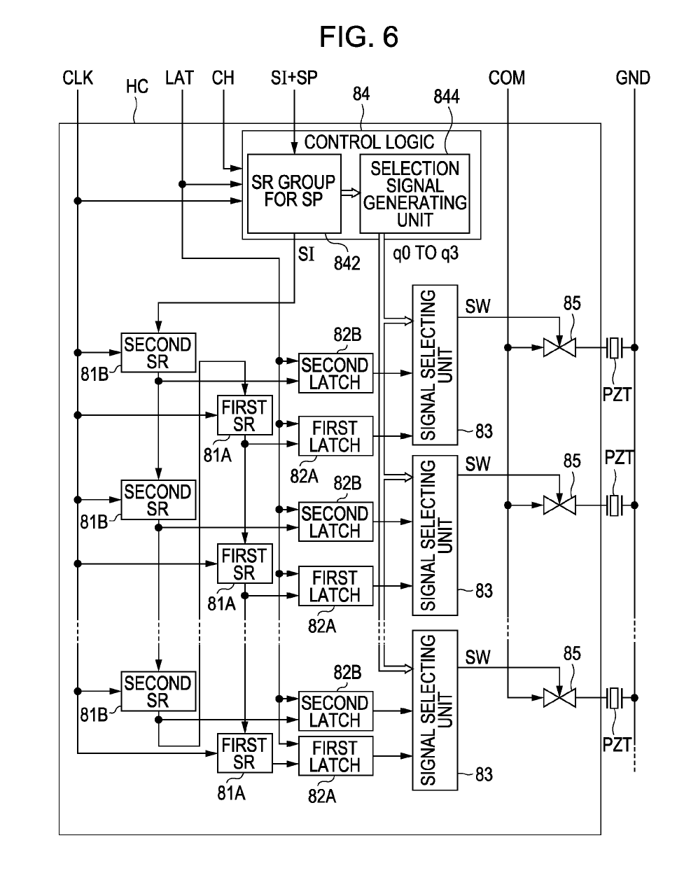

FIG. 6 is a block diagram showing the configuration of the head control unit of the reference example. The head control unit HC of the reference example includes a first shift register 81A, a second shift register 81B, a first latch circuit 82A, a second latch circuit 82B, a signal selecting part 83, a control logic 84, and a switch 85. The parts (that is, the first shift register 81A, the second shift register 81B, the first latch circuit 82A, the second latch circuit 82B, the signal selecting part 83, and the switch 85) except for the control logic 84 are disposed in each piezo element PZT. The control logic 84 includes a shift register group 842 for storing set data SP and a selection signal generating part 844 for generating selection signals q0 to q3 based on the set data SP.

To the head control unit HC, a clock CLK, a latch signal LAT, a change signal CH, and the driving signal COM are input from the main body-side controller 60 through the cable CBL. In addition, a setting signal including pixel data SI and the setting data SP is input to the head control unit HC from the main body-side controller 60 through the CBL.

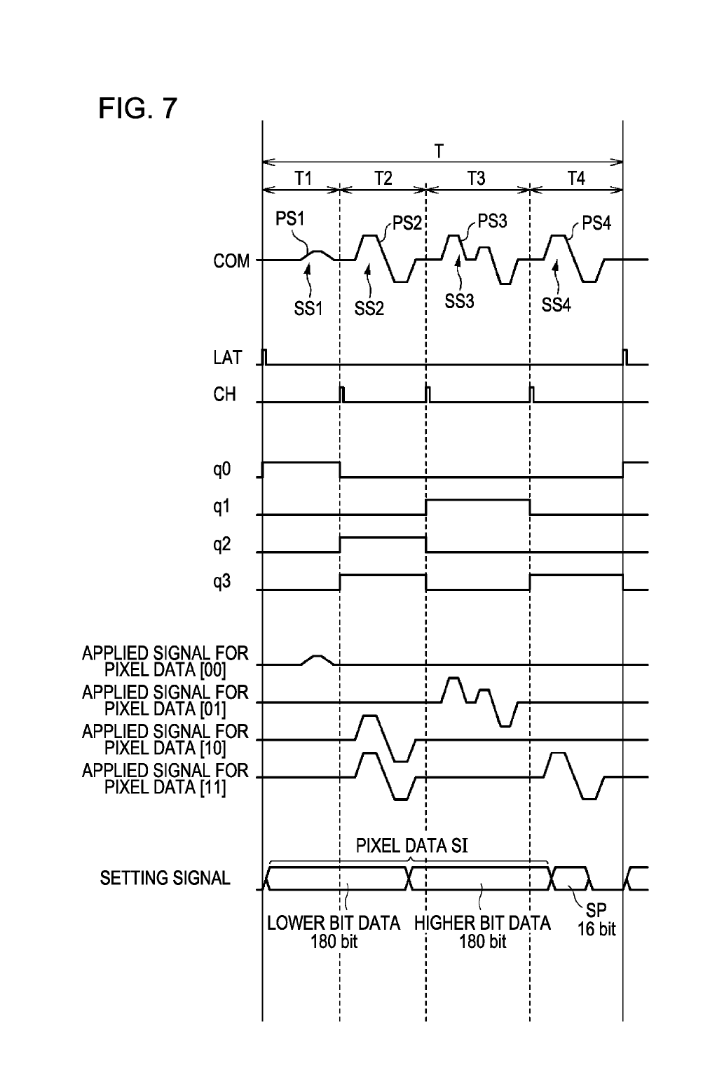

FIG. 7 is an explanatory diagram of various signals.

When the setting signal is input to the head control unit HC in synchronization with the clock CLK, lower bit data of the pixel data SI of the setting signal is set in the first shift register 81A, the upper bit data of the pixel data SI is set in the second shift register 81B, and the setting data SP is set in the shift register group 842 of the control logic 84. In addition, the lower bit of the two-bit pixel data corresponding to each nozzle is set in the first shift register 81A, and the upper bit of the two-bit pixel data is set in the second shift register 81B.

Then, in accordance with the pulse of the latch signal LAT, the lower bit data is latched in the first latch circuit 82A, the upper bit data is latched in the second latch circuit 82B, and the setting data SP is latched in the selection signal generating part 844. In addition, the lower bit of the two-bit pixel data corresponding to each nozzle is latched in the first latch circuit 82A and the upper bit of the two-bit pixel data is latched in the second latch circuit 82B.

The setting data SP is constituted by 16-bit data.

Then, the selection signal generating part 844 generates a selection signal q0 by setting level H or level L for four periods T1 to T4 which are defined by the latch signal LAT and the change signal CH based on the predetermined four-bit data of the 16-bit setting data SP. For example, four-bit data for the selection signal q0 is [1000]. Accordingly, the selection signal generating part 844 generates the selection signal q0 that has level H in the first period T1 and has level L in the second period T2 to the fourth period T4. In addition, the selection signal generating part 844 generates the selection signals q1 to q3 based on the predetermined four-bit data of the 16-bit setting data SP, in a similar manner.

The signal selecting part 83 selects one from among the selection signals q0 to q3 in accordance with the two-bit pixel data that is latched in the first latch circuit 82A and the second latch circuit 82B. When the pixel data is [00] (the lower bit is [0], and the upper bit is [0]), the selection signal q0 is selected, and when the pixel data is [01], the selection signal q1 is selected. On the other hand, when the pixel data is [10], the selection signal q2 is selected, and when the pixel data is [11], the selection signal q3 is selected. The selected selection signal is output from the signal selecting part 83 as a switch signal SW.

To the switch 85, the driving signal COM and the switch signal SW are input. When the switch signal is level H, the switch 85 is in the ON state, and accordingly, the driving signal COM is applied to the piezo element PZT. On the other hand, when the switch signal SW is level L, the switch 85 is in the OFF state, and accordingly, the driving signal COM is not applied to the piezo element PZT.

When the pixel data is [00], the switch 85 is turned ON OR OFF in accordance with the selection signal q0. Accordingly, the first interval signal SS1 of the driving signal COM is applied to the piezo element PZT, and the piezo element PZT is driven in accordance with the driving pulse PS1. When the piezo element PZT is driven in accordance with this driving pulse PS1, a pressure change that does not cause discharge of ink is generated in the ink, and accordingly, the ink meniscus (the free surface of the ink that is exposed to a nozzle part) vibrates minutely.

Similarly, when the pixel data is [01], ink droplets of 3 pl are discharged so as to form a small dot on the paper sheet. On the other hand, when the pixel data is [10], ink droplets of 7 pl are discharged so as to form a medium dot on the paper sheet. When the pixel data is [11], ink droplets of a total of 14 pl are discharged so as to form a large dot on the paper sheet.

During a period T, setting signals (the pixel data SI and the setting data SP) used for driving the piezo element PZT in the next period T are input to the head control unit HC.

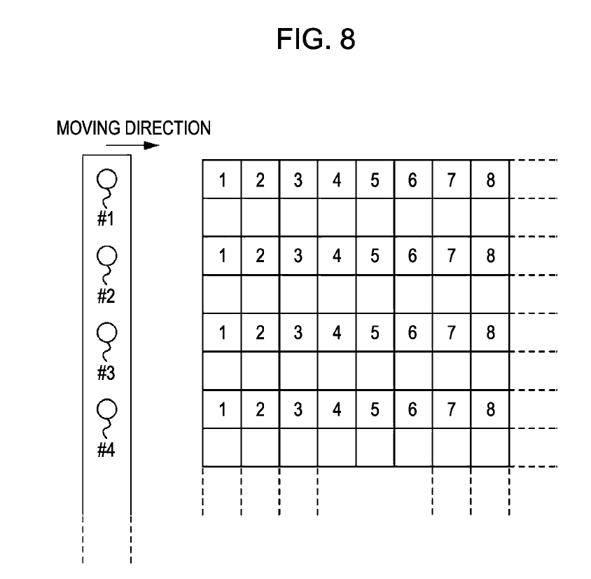

FIG. 8 is an explanatory diagram showing the sequence of the pixel data SI.

First, an image processing unit of the main body-side controller 60 (unit control circuit 64) extracts lower bit data of 180 pixel data corresponding to a pixel (hereinafter, referred to as a “first pixel”, and similarly, a pixel denoted by “n” in the figure is referred to as an “n-th pixel”) denoted by “1”, extracts upper bit data of the same pixel data, adds the setting data SP to the extracted pixel data, and transmits the resultant data to a data transfer unit. The data transfer unit transfers the data that is transmitted from the image processing unit to the head control unit HC as a setting signal in synchronization with the clock CLK. At this moment, the data transfer unit, first, transmits the lower bit data of the 180 pixel data to the head control unit HC in synchronization with the clock CLK. Next, the data transfer unit transmits the upper bit data of the 180 pixel data to the head control unit HC in synchronization with the clock CLK and, finally, transmits the setting data SP in synchronization with the clock CLK (see the diagram of setting signals of FIG. 7).

The head control unit HC sequentially stores the pixel data SI and the setting data SP of the setting signal transmitted from the data transfer unit of the main body-side controller 60 located on the main body side in the first shift register 81A, the second shift register 81B, and the shift register group 842. As a result, the lower bit data of the pixel data SI is set in the first shift register 81A, the upper bit data of the pixel data SI is set in the second shift register 81B, and the setting data SP is set in the shift register group 842 of the control logic 84. In accordance with the pulse of the latch signal LAT thereafter, the lower bit data is latched in the first latch circuit 82A, the upper bit data is latched in the second latch circuit 82B, and the setting data SP is latched in the selection signal generating part 844. Therefore, an ink droplet is discharged to the first pixel by the above-described operation.

After transmitting the pixel data SI (and the setting data SP) corresponding to the first pixel to the data transfer unit, the image processing unit of the main body-side controller 60 (unit control circuit 64) transmits the pixel data corresponding to the second pixel to the data transfer unit. To the data transfer unit, the pixel data SI (and the setting data SP) is sequentially transmitted from the image processing unit in synchronization with the latch signal LAT. In addition, to the head control unit HC, the pixel data SI (and the setting data SP) is sequentially transmitted from the data transfer unit in synchronization with the latch signal LAT.

Accordingly, the pixel data corresponding to a pixel is transmitted to the head control unit HC for a period T, and the pixel data corresponding to the next pixel is transmitted to the head control unit HC for the next period T. Then, during a period T in which, for example, the pixel data corresponding to a first pixel is latched in the first latch circuit 82A and the second latch circuit 82B and an ink droplet is discharged based on the pixel data corresponding to the first pixel, the lower bit data and the upper bit data of the pixel data corresponding to the second pixel and the setting data SP are transmitted to the head control unit HC in synchronization with the clock CLK. By repeating the above-described operation, as shown in FIG. 4, ink droplets are discharged from each nozzle with the period T, and thereby dots are formed with a pitch of 1/360 inch in the moving direction.

### Control Method 2 of Reference Example

In the description above, two-bit pixel data is in correspondence with each one pixel and four gray scales (no dot, a small dot, a medium dot, and a large dot) are represented by one dot. However, it may be configured that one-bit pixel data is in correspondence with each one pixel and two gray scales (no dot and a dot) are represented by presence and no-presence of a dot.

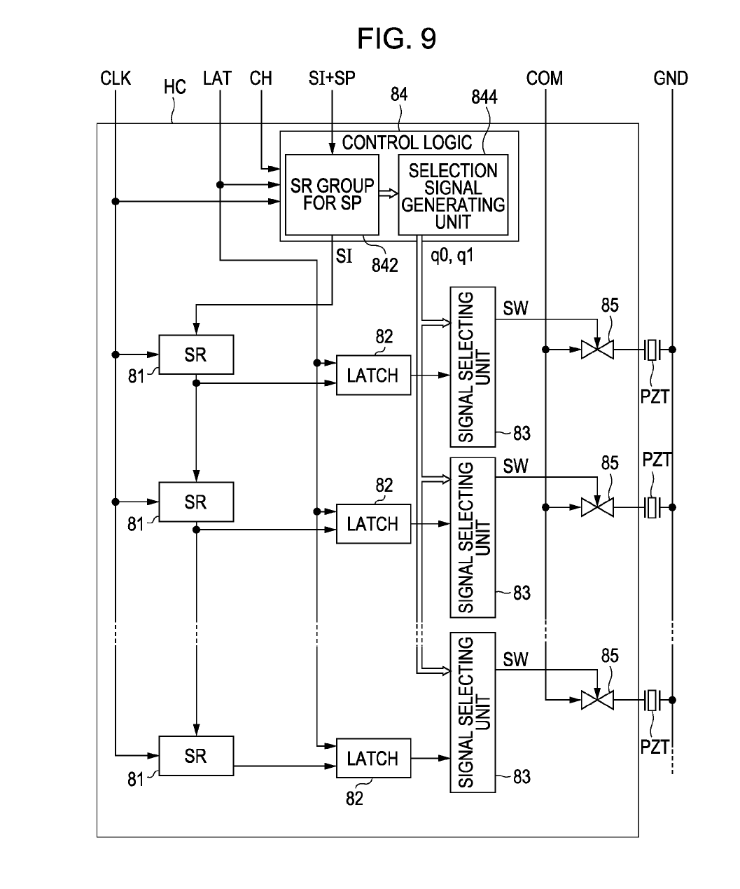

FIG. 9 is a block diagram showing the configuration of the head control unit for a case where the pixel data is one bit. A description of various signals that are input to the head control unit HC is omitted here.

When the setting signal is input to the head control unit HC in synchronization with the clock CLK, the pixel data SI of the setting signal is set in a shift register 81, and the setting data SP is set in the shift register group 842 of the control logic 84. Then, in accordance with the pulse of the latch signal LAT, the pixel data of one bit is latched in a latch circuit 82, and the setting data SP is latched in the selection signal generation part 844. The selection signal generation part 844 generates two selection signals (q0 and q1) based on the setting data SP. The signal selecting part 83 selects either the selection signal q0 or the selection signal q1 in accordance with the pixel data of one bit that is latched in the latch circuit 82. When the pixel data is [0], the switch 85 is turned ON OR OFF in accordance with the selection signal q0, and accordingly, any ink droplet is not discharged. As a result, in such a case, any dot is not formed. On the other hand, when the pixel data is [1], the switch 85 is turned ON OR OFF in accordance with the selection signal q1, and accordingly, an ink droplet is discharged. As a result, in such a case, a dot is formed.

For a Case where Head is Tilted in Reference Example

In the reference example, when the pixel data corresponding to the n-th pixel is transmitted from the main body-side controller 60 to the head control unit, ink droplets are simultaneously discharged from the nozzles in accordance with the pixel data corresponding to the n-th pixel. Accordingly, when the head is not tilted, dots are formed in a same position in the moving direction by the ink droplets simultaneously discharged from the nozzles (that is, dots are formed in the transport direction).

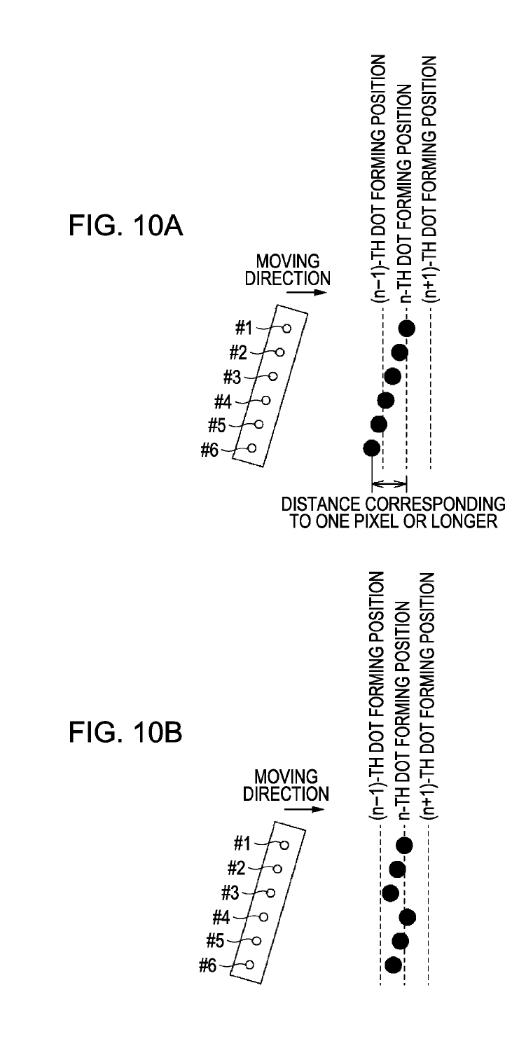

FIG. 10A is an explanatory diagram showing the appearance of dot formation for a case where the head is tilted in the reference example. Here, for the simplification of description, it is assumed that a nozzle row is configured by six nozzles (nozzle#1 to nozzle#6).

In a case where the head is tilted, when ink droplets are simultaneously discharged from the nozzles in accordance with the pixel data corresponding to the n-th pixel, as shown in the figure, the dots are formed to be deviated slightly in the moving direction. In other words, the dots are formed to be tilted with respect to the transport direction. As a result, as shown in the figure, a deviation between a dot formed by nozzle#1, which is located on the lowermost stream in the transport direction, and a dot formed by nozzle#6, which is located on the uppermost stream in the transport direction, in the transport direction may be longer than a distance corresponding to one pixel. As described above, when the deviation amount of the dots is large, the image quality of a printed image that is configured by countless dots deteriorates.

### First Embodiment

### Overview

FIG. 10B is an explanatory diagram showing the appearance of dot formation according to an embodiment of the invention for a case where the head is tilted. According to this embodiment, when ink droplets are discharged in accordance with pixel data corresponding to the n-th pixel, there is a difference between an ejection timing of nozzle#1 to nozzle#3 and an ejection timing of nozzle#4 to nozzle#6. For example, when nozzle#1 to nozzle#3 discharge ink droplets in accordance with pixel data corresponding to the n-th pixel, nozzle#4 to nozzle#6 discharge ink droplets in accordance with pixel data corresponding to the (n−1)-th pixel. In addition, when nozzle#4 to nozzle#6 discharge ink droplets in accordance with pixel data corresponding to the n-th pixel, nozzle#1 to nozzle#3 discharge ink droplets in accordance with pixel data corresponding to the (n+1)-th pixel.

In the embodiment described below, for the simplification of description, it is assumed that a nozzle row is configured by six nozzles (nozzle#1 to nozzle#6). In addition, in the embodiment described below, for the simplification of description, it is assumed that pixel data corresponding to one pixel is configured by one bit. When this embodiment is understood, a case where the number of nozzles is 180 or a case where pixel data corresponding to one pixel is configured by multiple bits can be understood.

### Head Control Unit of First Embodiment

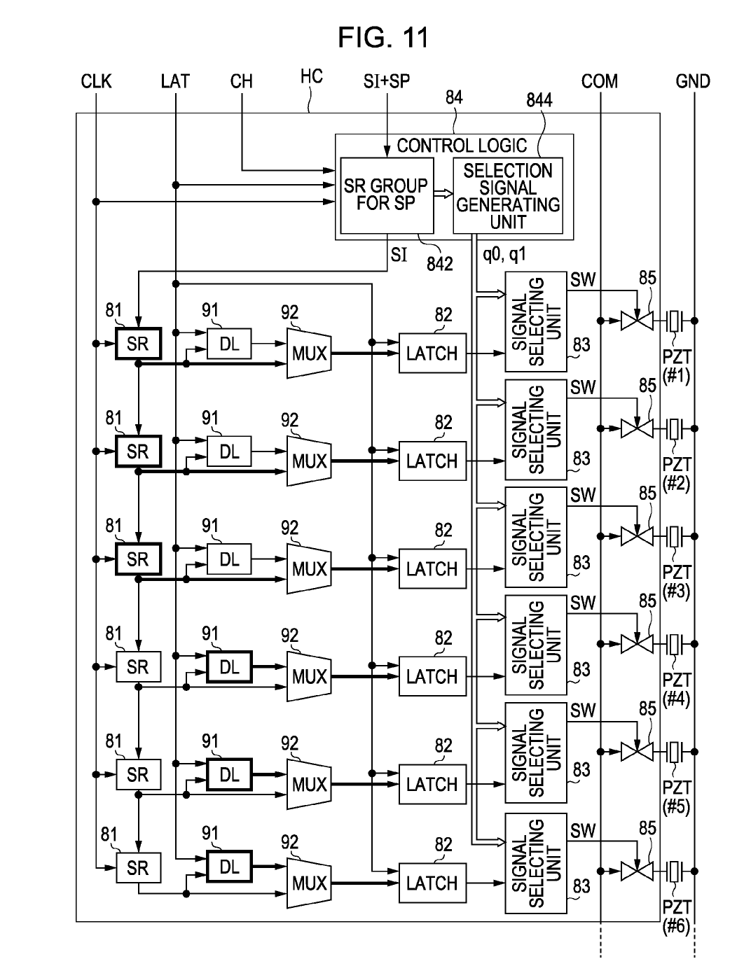

FIG. 11 is a block diagram showing the configuration of a head control unit according to the first embodiment of the invention. To each constituent element that is the same as that of the head control unit HC of the reference example, a same reference sign is assigned. The configuration of the head control unit HC of this embodiment is different from that of the head control unit HC of the reference example that a delay circuit 91 and a multiplexer 92 are disposed.

The head control unit HC according to the first embodiment includes a shift register 81, a latch circuit 82, a signal selecting part 83, a control logic 84, a switch 85, the delay circuit 91, and the multiplexer 92. The parts (that is, the shift register 81, the latch circuit 82, the signal selecting part 83, the switch 85, the delay circuit 91, and the multiplexer 92) except for the control logic 84 are disposed in each piezo element PZT.

The control logic 84 includes a shift register group 842 and a selection signal generating part 844. The shift register group 842 is configured by a plurality of shift registers for storing the setting data SP. The selection signal generating part 844 generates a selection signal q0 and a selection signal q1 based on the setting data SP.

To the head control unit HC, a clock CLK, a latch signal LAT, a change signal CH, and the driving signal COM are input from the main body-side controller 60 through the cable CBL. In addition, a setting signal including pixel data SI and the setting data SP is input to the head control unit HC from the main body-side controller 60 through the CBL.

When the setting signal is input to the head control unit HC in synchronization with the clock CLK, the pixel data SI (one bit for each one pixel) of the setting signal is set in the shift register 81, and the setting data SP is set in the shift register group 842 of the control logic 84.

The latch signal LAT is input to the control logic 84 and the delay circuit 91 and the latch circuit 82 of each nozzle. When the pulse of the latch signal LAT is input to the control logic 84, the setting data SP that is set in the shift register group 842 of the control logic 84 is latched in the selection signal generating part 844. When the pulse of the latch signal LAT is input to the delay circuit 91, the pixel data that is set in the shift register 81 is latched in the delay circuit 91. In addition, when the pulse of the latch signal LAT is input to the latch circuit 82, between the pixel data of the shift register 81 and the pixel data of the delay circuit 91, pixel data selected by the multiplexer 92 is latched in the latch circuit 82.

In addition, in the delay circuit 91, pixel data that is delayed from the pixel data set in the shift register 81 by one pixel is latched. For example, when the pixel data latched in the shift register 81 is in correspondence with the n-th pixel, the pixel data latched in the delay circuit 91 is in correspondence with the (n−1)-th pixel.

To the multiplexer 92, the pixel data of the shift register 81 and the pixel data of the delay circuit 91 are input. The multiplexer 92 is set in advance in accordance with a control signal not shown in the figure and outputs one between the pixel data of the shift register 81 and the pixel data of the delay circuit 91 to the latch circuit 82 in accordance with the control signal.

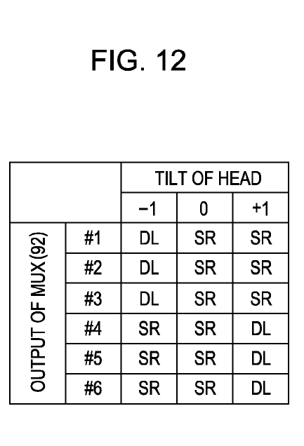

FIG. 12 is an explanatory diagram showing setting of the multiplexer according to the first embodiment. The tilt of the head in a state in which nozzle#1 is located on the downstream side in the moving direction relative to nozzle#6 is represent as “+” (plus). As shown in the figure, the setting of the multiplexer 92 is set in accordance with the tilted state of the head.

When the head is not tilted (or a deviation between a dot formed by nozzle#1 located in the lowermost stream in the transport direction and a dot formed by nozzle#6 located in the uppermost stream in the transport direction is shorter than a distance corresponding one pixel), all the multiplexers 92 are set so as to output the pixel data set in the shift register 81 to the latch circuit 82 (see the tilt of the head of “0” in FIG. 12).

On the other hand, when the head is tilted as shown in FIG. 10B, as denoted by thick lines shown in FIG. 11, the multiplexers 92 corresponding to nozzle#1 to nozzle#3 are set so as to select the output of the shift register 81, and the multiplexers 92 corresponding to nozzle#4 to nozzle#6 are set so as to select the output of the delay circuit 91 (see the tilt of the head of “+1” in FIG. 12). As a result, when pixel data corresponding to the n-th pixel is latched in the latch circuits 82 corresponding to nozzle#1 to nozzle#3, pixel data corresponding to the (n−1)-th pixel is latched in the latch circuits 82 corresponding to nozzle#4 to nozzle#6.

On the other hand, when the head is tilted to the side opposite to the side to which the head shown in FIG. 10B is tilted, the multiplexers 92 corresponding to nozzle#1 to nozzle#3 are set so as to select the output of the delay circuit 91, and the multiplexers 92 corresponding to nozzle#4 to nozzle#6 are set so as to select the output of the shift register 81 (see the tilt of the head of “−1” in FIG. 12).

In addition, the setting states of six multiplexers are the above-described three-state settings. Thus, the setting states of three multiplexers corresponding to nozzle#1 to nozzle#3 are common, and the setting states of three multiplexers corresponding to nozzle#4 to nozzle#6 are common, as well. Accordingly, it is preferable that simplification of the head control circuit is implemented by using the control signal (not shown) for three multiplexers corresponding to nozzle#1 to nozzle#3 commonly and using the control signal for three multiplexers corresponding to nozzle#4 to nozzle#6 commonly.

The selection signal generating part 844 generates two selection signals (q0 and q1) based on the setting data SP. The signal selecting part 83 selects either the selection signal q0 or the selection signal q1 in accordance with the pixel data of one bit that is latched in the latch circuit 82. When the pixel data is [0], the switch 85 is turned ON OR OFF in accordance with the selection signal q0, and accordingly, any ink droplet is not discharged. As a result, in such a case, any dot is not formed. On the other hand, when the pixel data is [1], the switch 85 is turned ON OR OFF in accordance with the selection signal q1, and accordingly, an ink droplet is discharged. As a result, in such a case, a dot is formed.

In a case where the multiplexers 92 are set as denoted by thick lines shown in FIG. 11, when nozzle#1 to nozzle#3 discharge ink droplets in accordance with pixel data corresponding to the n-th pixel, nozzle#4 to nozzle#6 discharge ink droplets in accordance with pixel data corresponding to the (n−1)-th pixel.

As a result, as shown in FIG. 10B, dots corresponding to data of the n-th pixel are formed. Accordingly, the deviation of dots can be corrected such that the deviation between a target formation position and an actual position is shorter than a distance corresponding to one pixel. In addition, a deviation between the dot, which is formed by nozzle#1 located in the lowermost stream, and the dot, which is formed by nozzle#6 located in the uppermost stream, in the moving direction can be configured shorter than the distance corresponding to one pixel. As described above, by correcting the deviation of dots, the image quality of a printed image is improved.

In addition, in description above, although the settings of the multiplexers are changed so as to correct the deviation of dots for a case where the head is tilted, however, the setting states of the multiplexers are not limited thereto. For example, the setting of the multiplexer corresponding to each nozzle may be changed in accordance with characteristics (the ink discharging direction and the ink discharging speed) of the nozzle. Accordingly, when dots are deviated such that the dots are scattered due to characteristics of each nozzle, the deviation of the dots can be corrected.

In addition, it is preferable that the settings of the multiplexers 92 are controlled by disposing a register inside the head control unit HC and transmitting data from the unit control circuit 64 thereto. In such a case, when one-bit register is disposed for each nozzle, the nozzles can be controlled individually. In addition, it may be configured that two-bit register (capable of identifying four states) is disposed, and one of three states of the tilt of the head including “−1”, “0”, and “1” shown in FIG. 12 is selected. In addition, instead of the register, the control line may be controlled by the main body-side controller 60 through the flat cable CBL. This applies to other embodiments of the invention, as well.

In addition, it is preferable that the correction process is performed by performing a printing process with the head installed and checking the tilt of the head based on the result of the printing process. In such a case, the deviation can be adjusted by performing a simple electrical control process instead of a fine mechanical adjustment that cannot be performed easily.

### Second Embodiment

Under the configuration of the head control unit HC according to the first embodiment, the dots can be displaced by only a distance corresponding to one pixel. However, when the tilt of the head is large, the dots may be needed to be displaced by a distance corresponding to more than one pixel. In a second embodiment of the invention, the configuration of a head control unit HC capable of displacing the dots by a distance corresponding to more than one pixel will be described.

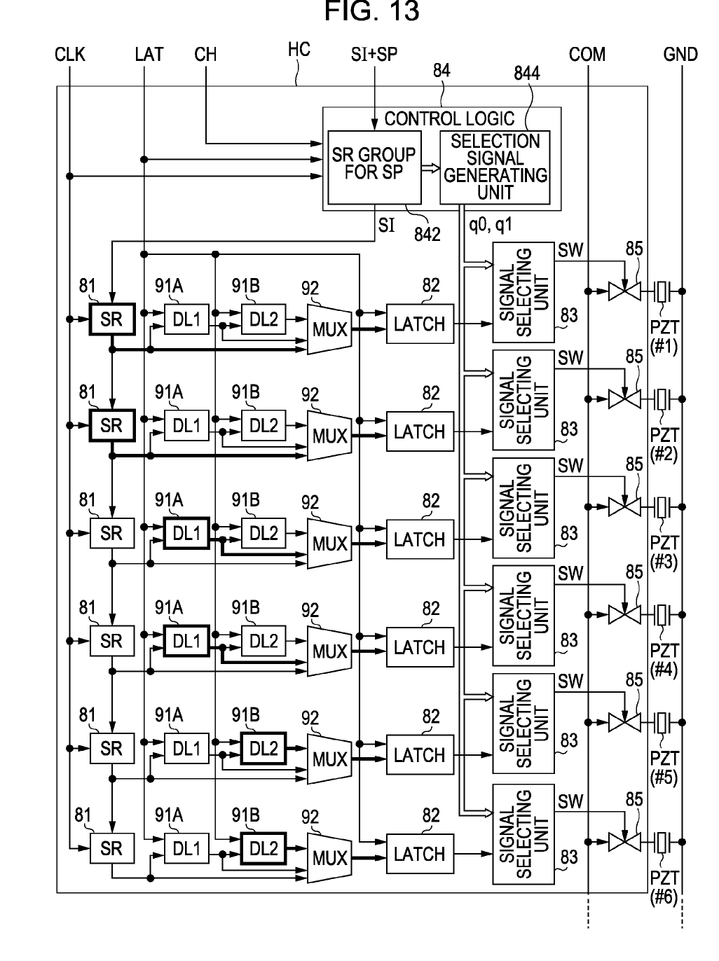

FIG. 13 is a block diagram showing the configuration of a head control unit according to the second embodiment. To each constituent element that is the same as that of the head control unit HC according to the first embodiment, a same reference sign is assigned. The configuration of the head control unit HC according to this embodiment is different from that of the head control unit HC according to the first embodiment that two delay circuits are disposed for each nozzle.

The head control unit HC according to the second embodiment includes a shift register 81, a latch circuit 82, a signal selecting part 83, a control logic 84, a switch 85, a first delay circuit 91A, a second delay circuit 91B, and a multiplexer 92. The parts (that is, the shift register 81, the latch circuit 82, the signal selecting part 83, the switch 85, the first delay circuit 91A, the second delay circuit 91B, and the multiplexer 92) except for the control logic 84 are disposed in each piezo element PZT.

The latch signal LAT is input to the control logic 84 and the first delay circuit 91A, the second delay circuit 91B, the latch circuit 82 of each nozzle. When the pulse of the latch signal LAT is input to the control logic 84, the setting data SP that is set in the shift register group 842 of the control logic 84 is latched in the selection signal generating part 844. When the pulse of the latch signal LAT is input to the first delay circuit 91A, the pixel data that is set in the shift register 81 is latched in the first delay circuit 91A. When the pulse of the latch signal LAT is input to the second delay circuit 91B, the pixel data that is set in the first delay circuit 91A is latched in the second delay circuit 91B. In addition, when the pulse of the latch signal LAT is input to the latch circuit 82, among the pixel data of the shift register 81, the pixel data of the first delay circuit 91A, and the pixel data of the second delay circuit 91B, pixel data selected by the multiplexer 92 is latched in the latch circuit 82.

In addition, in the first delay circuit 91A, pixel data that is delayed from the pixel data set in the shift register 81 by one pixel is latched. For example, when the pixel data latched in the shift register 81 is in correspondence with the n-th pixel, the pixel data latched in the first delay circuit 91A is in correspondence with the (n−1)-th pixel.

In addition, in the second delay circuit 91B, pixel data that is delayed from the pixel data set in the shift register 81 by two pixels is latched. For example, when the pixel data latched in the shift register 81 is in correspondence with the n-th pixel, the pixel data latched in the second delay circuit 91B is in correspondence with the (n−2)-th pixel.

To the multiplexer 92, the pixel data of the shift register 81, the pixel data of the first delay circuit 91A, and the pixel data of the second delay circuit 91B are input. The multiplexer 92 is set in advance in accordance with a control signal not shown in the figure and outputs one among the pixel data of the shift register 81, the pixel data of the first delay circuit 91A, and the pixel data of the second delay circuit 91B to the latch circuit 82 in accordance with the control signal.

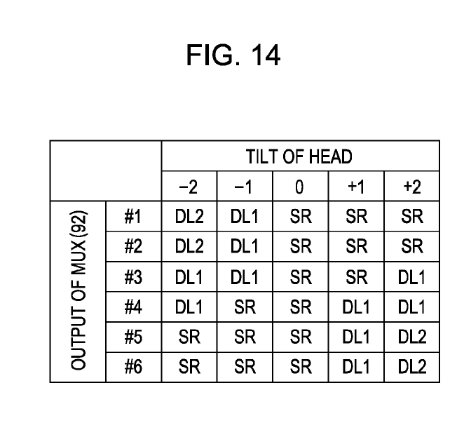

FIG. 14 is an explanatory diagram showing setting of the multiplexer according to the second embodiment.

When the head is not tilted (or a deviation between a dot formed by nozzle#1 located in the lowermost stream in the transport direction and a dot formed by nozzle#6 located in the uppermost stream in the transport direction is shorter than a distance corresponding one pixel), all the multiplexers 92 are set so as to output the pixel data set in the shift register 81 to the latch circuit 82 (see the tilt of the head of “0” in FIG. 14).

When the head is tilted by one pixel (for a case where the head is tilted such that nozzle#1 is disposed on the downstream side in the moving direction), the multiplexers 92 corresponding to nozzle#1 to nozzle#3 are set so as to select the output of the shift register 81, and the multiplexers 92 corresponding to nozzle#4 to nozzle#6 are set so as to select the output of the first delay circuit 91A (see the tilt of the head of “+1” in FIG. 14). As a result, when pixel data corresponding to the n-th pixel is latched in the latch circuits 82 corresponding to nozzle#1 to nozzle#3, pixel data corresponding to the (n−1)-th pixel is latched in the latch circuits 82 corresponding to nozzle#4 to nozzle#6.

When the head is tilted by two pixels (for a case where the head is tilted such that nozzle#1 is disposed on the downstream side in the moving direction), as denoted by thick lines shown in FIG. 13, the multiplexers 92 corresponding to nozzle#1 and nozzle#2 are set so as to select the output of the shift register 81, the multiplexers 92 corresponding to nozzle#3 and nozzle#4 are set so as to select the output of the first delay circuit 91A, and the multiplexers 92 corresponding to nozzle#5 and nozzle#6 are set so as to select the output of the second delay circuit 91B (see the tilt of the head of “+2” in FIG. 14). As a result, when pixel data corresponding to the n-th pixel is latched in the latch circuits 82 corresponding to nozzle#1 and nozzle#2, pixel data corresponding to the (n−1)-th pixel is latched in the latch circuits 82 corresponding to nozzle#3 to nozzle#4, and pixel data corresponding to the (n−2)-th pixel is latched in the latch circuits 82 corresponding to nozzle#5 to nozzle#6.

When the second embodiment is understood, the configuration of a head control unit HC that is capable of displacing the dots by a distance corresponding to three pixels or more can be understood, and thus, a description thereof is omitted here.

In addition, in description above, although the settings of the multiplexers are changed so as to correct the deviation of dots for a case where the head is tilted, however, the setting states of the multiplexers are not limited thereto. For example, the setting of the multiplexer corresponding to each nozzle may be changed in accordance with characteristics (the ink discharging direction and the ink discharging speed) of the nozzle.

Accordingly, when dots are deviated such that the dots are scattered due to characteristics of each nozzle, the deviation of the dots can be corrected.

### Third Embodiment

In the above-described embodiments, the delay circuits corresponding to the number of nozzles are needed to be prepared. However, according to a third embodiment of the invention, the number of the delay circuits is decreased.

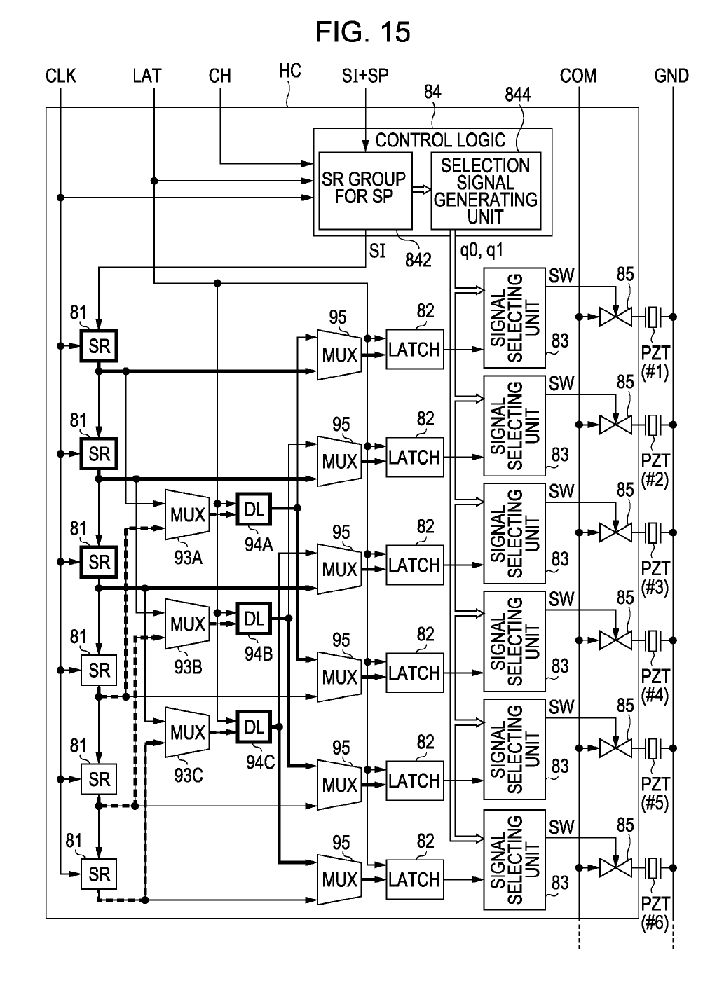

FIG. 15 is a block diagram showing the configuration of a head control unit according to the third embodiment. To each constituent element that is the same as that of the head control unit HC according to the first embodiment, a same reference sign is assigned.

The head control unit HC according to the third embodiment includes a shift register 81, a latch circuit 82, a signal selecting part 83, a control logic 84, a switch 85, a first multiplexer 93, a delay circuit 94, and a second multiplexer 95. Among these constituent elements, the shift register 81, the latch circuit 82, the signal selecting part 83, the switch 85, and the second multiplexer 95 are disposed in each piezo element PZT. On the other hand, the first multiplexers 93 and the delay circuits 94 corresponding to half the total number (here, three) of the piezo elements PZT are disposed.

To the first multiplexer 93A, pixel data that is set in a total of two shift registers 81 including a shift register 81 corresponding to a nozzle that is located on the downstream side in the transport direction and a shift register 81 corresponding to a nozzle that is located on the upstream side in the transport direction is input. For example, to the first multiplexer 93A, pixel data that is set in the shift register 81 corresponding to nozzle#1 and pixel data set in the shift register 81 corresponding to nozzle#4 are input. The first multiplexer 93A is set in advance in accordance with a control signal not shown in the figure and outputs one of pixel data of two shift registers to the delay circuit 94 in accordance with the control signal.

The delay circuit 94 outputs the pixel data to a total of two multiplexers including the second multiplexer 95 corresponding to the nozzle that is located on the downstream side in the transport direction and the second multiplexer 95 corresponding to the nozzle that is located on the upstream side in the transport direction. For example, the delay circuit 94A outputs the pixel data to the second multiplexer 95 corresponding to nozzle#1 and the second multiplexer 95 corresponding to nozzle#4.

The latch signal LAT is input to the control logic 84, the delay circuits 94A to 94C, and the latch circuit 82 of each nozzle. When the pulse of the latch signal LAT is input to the control logic 84, the setting data SP that is set in the shift register group 842 of the control logic 84 is latched in the selection signal generating part 844. When the pulse of the latch signal LAT is input to the delay circuit 94, pixel data set in two shift registers 81 which is selected by the first multiplexer 93 is latched in the delay circuit 94. When the pulse of the latch signal LAT is input to the latch circuit 82, between the pixel data of the shift register 81 and the pixel data of the delay circuit 94, pixel data selected by the second multiplexer 95 is latched in the latch circuit 82.

In addition, in the delay circuit 94, pixel data that is delayed from the pixel data set in the shift register 81 by one pixel is latched. For example, when the pixel data latched in the shift register 81 is in correspondence with the n-th pixel, the pixel data latched in the delay circuit 94 is in correspondence with the (n−1)-th pixel.

To the second multiplexer 95, the pixel data of the shift register 81 and the pixel data of the delay circuit 94 are input. The second multiplexer 95 is set in advance in accordance with a control signal not shown in the figure and outputs one between the pixel data of the shift register 81 and the pixel data of the delay circuit 94 to the latch circuit 82 in accordance with the control signal.

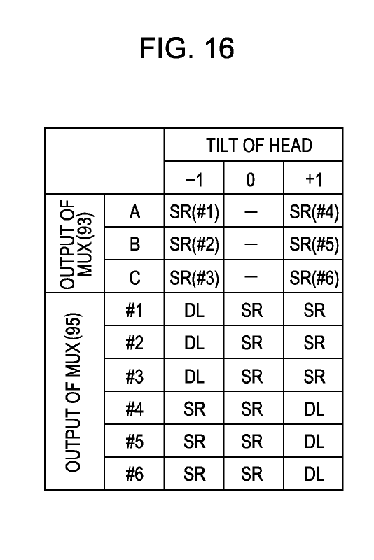

FIG. 16 is an explanatory diagram showing settings of the first multiplexer 93 and the second multiplexer 95 according to the third embodiment.

When the head is not tilted (or a deviation between a dot formed by nozzle#1 located in the lowermost stream in the transport direction and a dot formed by nozzle#6 located in the uppermost stream in the transport direction is shorter than a distance corresponding one pixel), all the second multiplexers 95 are set so as to output the pixel data set in the shift register 81 to the latch circuit 82 (see the tilt of the head of “0” in FIG. 16). Accordingly, when the head is not tilted, the pixel data latched in the delay circuit 94 is not used. Thus, in such a case, the setting of the first multiplexer 93 may be arbitrary.

On the other hand, when the head is tilted as shown in FIG. 10B, as denoted by thick lines shown in FIG. 16, the first multiplexer 93 is set so as to select the output of the shift register 81 corresponding to a nozzle located on the upstream side in the transport direction (see the tilt of the head of “+1” in FIG. 16). In addition, the second multiplexers 95 corresponding to nozzle#1 to nozzle#3 are set so as to select the output of the shift register 81, and the second multiplexers 95 corresponding to nozzle#4 to nozzle#6 are set so as to select the output of the delay circuit 94 (see the tilt of the head of “+1” in FIG. 16). As a result, when pixel data corresponding to the n-th pixel is latched in the latch circuits 82 corresponding to nozzle#1 to nozzle#3, pixel data corresponding to the (n−1)-th pixel is latched in the latch circuits 82 corresponding to nozzle#4 to nozzle#6.

On the other hand, when the head is tilted to the side opposite to the side to which the head shown in FIG. 10B is tilted, the first multiplexer 93 is set so as to select the output of the shift register 81 corresponding to a nozzle located on the downstream side in the transport direction (see the tilt of the head of “−1” in FIG. 16). In addition, the second multiplexers 95 corresponding to nozzle#1 to nozzle#3 are set so as to select the output of the delay circuit 94, and the second multiplexers 95 corresponding to nozzle#4 to nozzle#6 are set so as to select the output of the shift register 81 (see the tilt of the head of “−1” in FIG. 16).

In addition, the setting states of six second multiplexers 95 are the above-described three-state settings. Thus, the setting states of three second multiplexers 95 corresponding to nozzle#1 to nozzle#3 are common, and the setting states of three second multiplexers 95 corresponding to nozzle#4 to nozzle#6 are common, as well. Accordingly, it is preferable that simplification of the head control circuit is implemented by using the control signal (not shown) for three second multiplexers 95 corresponding to nozzle#1 to nozzle#3 commonly and using the control signal for three second multiplexers 95 corresponding to nozzle#4 to nozzle#6 commonly.

In addition, the setting states of three first multiplexers 93 are the above-described three-state settings and are common. Thus, it is preferable that the head control circuit is simplified by using the control signal of three first multiplexers 93 commonly.

When three second multiplexers 95 corresponding to nozzle#1 to nozzle#3 are set so as to select the output of the delay circuit 94, three first multiplexers 93 are set so as to select the output of the shift registers 82 corresponding to nozzle#1 to nozzle#3 (see the tilt of the head of “−1” shown in FIG. 16). On the contrary, when three second multiplexers 95 corresponding to nozzle#4 to nozzle#6 are set so as to select the output of the delay circuit 94, three first multiplexers 93 are set so as to select the output of the shift registers 82 corresponding to nozzle#4 to nozzle#6 (see the tilt of the head of “+1” shown in FIG. 16). Thus, it is preferable that the head control circuit is simplified by commonly using the control signal of three first multiplexers 93 as the control signal of three second multiplexers 95 of nozze#1 to nozzle#3 or nozzle#4 to nozzle#6.

In addition, when the third embodiment is understood, the configuration of a head control unit HC that can displace the dots by a distance corresponding to two pixels or more and has the delay circuits corresponding to half the number of the delay circuits according to the second embodiment can be understood, and thus, a description thereof is omitted here.

In the above-described first and second embodiments, when dots are deviated to be scattered for each nozzle due to the characteristics of the nozzle, the deviation of the dots can be corrected by changing the settings of the multiplexers corresponding to each nozzle in accordance with the individual characteristics (the ink discharging direction and the ink discharging speed) of the nozzles. On the other hand, in the third embodiment, the configuration in which the number of the delay circuits are decreased by half is used, and thus, correction of the deviation of dots for each nozzle is restricted.

### Fourth Embodiment

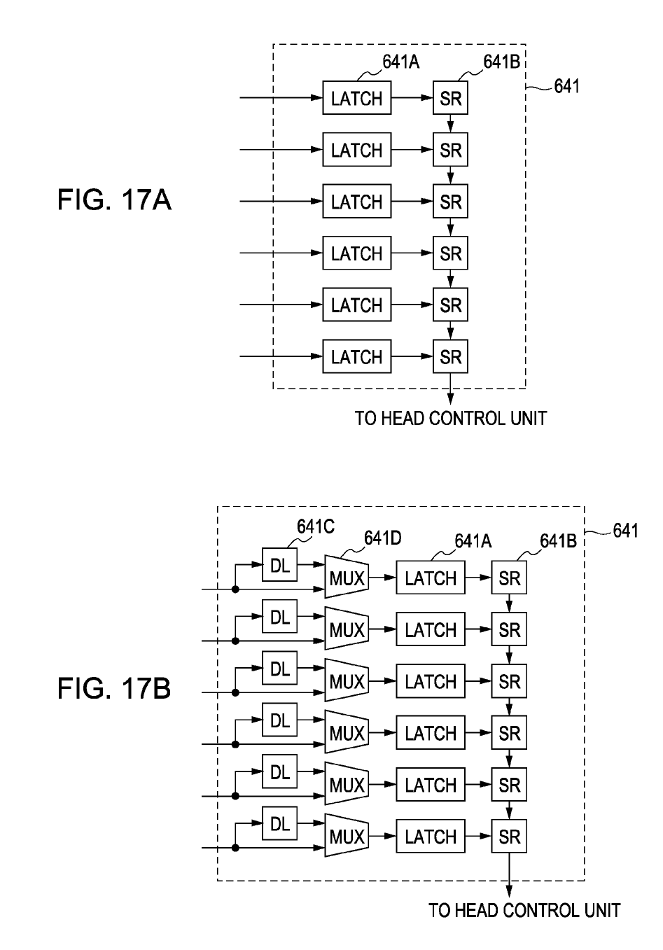

FIG. 17A is an explanatory diagram of the data transfer unit 641 according to the reference example and the first to third embodiments. This data transfer unit 641 is disposed in the unit control circuit 64 of the main body-side controller 60. At a timing (a timing synchronized with the pulse of the latch signal LAT), the pixel data is latched in the latch circuit 641A, and the pixel data latched in the latch circuit 641A is set in the shift register 641B. The pixel data set in the shift register 641B is serially transferred in synchronization with the clock CLK to the head control unit HC of the head unit 40 through the cable CBL (here, for the simplification of description, a description of the setting data SP is omitted).

On the other hand, according to the fourth embodiment, when the pixel data is transferred to the head control unit HC, a predetermined transfer timing for the pixel data is configured to be delayed.

FIG. 17B is an explanatory diagram of a data transfer unit according to the fourth embodiment. Compared to the data transfer unit shown in FIG. 17A, a delay circuit 641C and a multiplexer 641D are disposed in the data transfer unit according to the fourth embodiment. At a timing (a timing synchronized with the pulse of the latch signal LAT), either pixel data input to the data transfer unit or pixel data latched in the delay circuit which is selected by the multiplexer 641D is latched in the latch circuit 641A. The pixel data input to the data transfer unit is latched in the delay circuit 641C at the timing the pixel data is latched in the latch circuit 641A. Accordingly, pixel data that is delayed from the pixel data input to the data transfer unit by one pixel is latched in the delay circuit 641C. For example, when the pixel data input to the data transfer unit corresponds to the n-th pixel data, the pixel data latched in the delay circuit 641C corresponds to the (n−1)-th pixel.

Then, the pixel data latched in the latch circuit 641A is set in the shift register 641B, and the pixel data set in the shift register 641B is serially transferred in synchronization with the clock CLK to the head control unit HC of the head unit 40 though the cable CBL.

When the head is tilted as shown in FIG. 10B, as denoted by thick lines shown in FIG. 17B, the multiplexers 641D corresponding to nozzle#1 to nozzle#3 are set so as to select the pixel data that is input to the data transfer unit, and the multiplexers 641D corresponding to nozzle#4 to nozzle#6 are set so as to select the output of the delay circuit 641C. As a result, when pixel data corresponding to the n-th pixel is latched in the latch circuits 641A corresponding to nozzle#1 to nozzle#3, pixel data corresponding to the (n−1)-th pixel is latched in the latch circuits 641A corresponding to nozzle#4 to nozzle#6. When the pixel data is serially transferred to the head control unit HC in synchronization with the clock CLK, the pixel data corresponding to nozzle#4 to nozzle#6 is delayed from the pixel data corresponding to nozzle#1 to nozzle#3 by one pixel.

When the above-described data transfer unit 641 is disposed in the unit control circuit 64, it is preferable that the head control unit HC of the reference example is disposed in the head unit 40. In such a case, the head control unit HC according to the first to third embodiments is not needed.

When the fourth embodiment is understood, a configuration in which a dot can be displaced by two pixels or more, as in the second embodiment, or a configuration in which the number of the delay circuits 641C is decreased, as in the third embodiment can be understood, and thus, a description thereof is omitted here.

### Other Embodiments

In the above-described embodiments, the printer has been mainly described. However, it is apparent that a printing apparatus, a recording apparatus, a liquid discharging apparatus, a printing method, a recording method, a method of discharging liquid, a printing system, a recording system, a computer system, a program, a storage medium having the program stored thereon, a display screen, a method of displaying a screen, a method of manufacturing a printed material, and the like are disclosed therein.

In addition, the printer or the like as an embodiment of the invention has been described. However, the above-described embodiments are for gaining a sufficient understanding of the invention and are not for purposes of limitation. It is apparent that the invention may be changed or modified without departing from the gist thereof and equivalents thereof belong to the scope of the invention. In particular, embodiments described below belong to the scope of the invention.

### Printer 1

In the above-described embodiments, the printer has been described. However, the invention is not limited thereto. For example, the same technology as that in the above-described embodiments may be applied to various liquid discharging apparatuses that utilize ink jet technology such as a color filter manufacturing apparatus, a coloring apparatus, a microfabrication processing apparatus, a semiconductor manufacturing apparatus, a surface processing apparatus, a three-dimensional modeling apparatus, a liquid vaporizing apparatus, an organic EL manufacturing apparatus (particularly, a polymer EL manufacturing apparatus), a display manufacturing apparatus, a deposition apparatus, and a DNA chip manufacturing apparatus. In addition, such a method or a manufacturing method is within the range of application of the invention. Even when the present technology is applied in such fields, the liquid can be directly discharged (direct drawing) toward a target object, and accordingly save of the material, save of the process, and cost-down can be achieved, compared to a general case.

### Printer 2

In the above-described embodiments, a serial printer in which a head is moved with respect to a paper sheet by a carriage has been described. However, the invention is not limited thereto. For example, a line printer in which a head is fixed and a paper sheet is moved with respect to the head may be used.

### Ink

In the above-described embodiments, printers have been described, and thus, dye ink or pigment ink is discharged from the nozzles. However, the liquid discharged from the nozzles is not limited thereto. For example, liquid (including water) such as a metal material, an organic material (particularly, a polymer material), a magnetic material, a conductive material, a wiring material, a deposition material, electronic ink, a processing solution, or a gene solution may be discharged from the nozzles. When such liquid is directly discharged toward a target object, save of the material, save of the process, and cost-down can be achieved.

### Nozzle

In the above-described embodiments, ink is discharged by using a piezo element. However, a method of discharging liquid is not limited thereto. For example, a method of generating bubbles within the nozzles by using heat, or any other method may be used.

### Summing Up

In the printer (an example of a liquid discharging apparatus) according to the above-described first to third embodiments, in order to store pixel data that is used for controlling nozzles of nozzle#1 to nozzle#6 and discharge of ink droplets (corresponding to liquid droplets) from the nozzles, six latch circuits 82 (corresponding to first storage units) that are disposed for each nozzle are included. Then, the pixel data transmitted from the data transfer unit for each period of a predetermined period T (which is also a period of the pulse of a latch signal) is stored in the latch circuit 82 in accordance with the pulse of the latch signal, and ink droplets are discharged from the nozzles based on the pixel data stored in the latch circuit 82 for each period T.

In addition, as a second storage unit for storing the pixel data transmitted at a timing, the delay circuit 91 is disposed according to the first embodiment, and the first delay circuit 91A is disposed according to the second embodiment, and the delay circuit 94 is disposed according to the third embodiment. In addition, as a data selecting unit that selects whether the pixel data is directly stored from the shift register 81 not through the delay circuit or the pixel data is stored through the delay circuit at a time when the pixel data is stored in the latch circuit 82, the multiplexer 92 is disposed according to the first and second embodiments, and the second multiplexer 95 is disposed according to the third embodiment.

Under such a configuration, a timing when the pixel data is stored in the latch circuit can be delayed from a timing when the pixel data is transmitted to the head control unit. Accordingly, the deviation of dots can be corrected without changing the image processing of the image proceeding unit. Conversely, under the above-described configuration only, the deviation of dots can be corrected, and all the constituent elements of the above-described embodiments are not necessary. For example, when ink is discharged from nozzles based on the pixel data stored in the latch circuit 82, the configuration of the signal selecting part 83, the switch 85, or the piezo element PZT is not essentially needed. Thus, for example, the piezo element PZT may be configured to be replaced by a heater.

In addition, according to the fourth embodiment, the delay circuit 641C of the data transfer unit 641 on the main body side corresponds to a second storage unit, and the multiplexer 641D of the data transfer unit 641 on the main body side corresponds to data selecting unit. Even under such a configuration, a timing when the pixel data is latched in the latch circuit can be delayed from a timing when the pixel data is transmitted to the data transfer unit, and accordingly, the deviation of dots can be corrected.

According to the above-described second embodiment, the second delay circuit 91B for storing pixel data transmitted at a timing prior to a timing when the pixel data stored in the first delay circuit 91A (corresponding to a second storage unit) is transmitted is disposed. Then, the multiplexer 92 selects one among pixel data stored in the shift register 81, pixel data stored in the first delay circuit 91A, and pixel data stored in the second delay circuit 91B and stores the selected pixel data in the latch circuit 82.

According to the second embodiment having the above-described configuration, it is possible to correct the deviation of dots for two pixels or more.

According to the above-described first and second embodiments, the delay circuit 91 and the multiplexer 92 are disposed in correspondence with each nozzle (that is, in correspondence with each latch circuit 82 of the nozzles). Under such a configuration, in the first and second embodiments, the deviation of dots for each nozzle can be corrected. Accordingly, not only for a case where there is the deviation of dots due to the tilt of the head but also for a case where there is the deviation of dots to be scattered for the nozzles due to individual characteristics of the nozzles, the deviation of dots can be corrected.

According to the above-describe third embodiment, the first multiplexer 93A (corresponding to a third data selecting unit) selects either pixel data (corresponding to first data) transmitted to nozzle#1 or pixel data (corresponding to second data) transmitted to nozzle#4 and outputs the selected pixel data to the delay circuit 94A (corresponding to a second storage unit). Then, when the pixel data transmitted to nozzle#4 is stored in the delay circuit 94A, the multiplexer 95 corresponding to nozzle#1 outputs not the pixel data of the delay circuit 94A but the pixel data of the shift register 81 to the latch circuit 82, and the multiplexer 95 corresponding to nozzle#4 outputs the pixel data of the delay circuit 94A to the latch circuit 82.

According to the third embodiment having the above-described configuration, the number of the delay circuits can be decreased.

According to the above-described first to third embodiments, the delay circuit (corresponding to a second storage unit) is disposed in the head control unit HC that is disposed on the carriage side. However, the delay circuit may not be disposed on the carriage side.

For example, according to the fourth embodiment, the delay circuit 641C is disposed in the data transfer unit of the main-side controller. Even under such a configuration, the deviation of dots can be corrected without changing the image processing of the image processing unit.

In the above-described embodiments, the configuration of a printer has been described. However, in the descriptions thereof, a method of discharging liquid droplets is also included. According to the method of discharging liquid of the above-described embodiments, the deviation of dots can be corrected.

What is claimed is:

1. A liquid discharging apparatus that stores data transmitted at each timing of a predetermined period in a plurality of first storage units for the each timing and discharges liquid droplets from a plurality of nozzles based on the data stored in the plurality of first storage units for the each timing, the liquid discharging apparatus comprising:
the plurality of the nozzles;
the plurality of first storage units that is disposed for the plurality of nozzles for storing the data for controlling discharge of the liquid droplets from the plurality of nozzles;
a second storage unit that is used for storing the data transmitted at a timing; and
a data selecting unit that is used for selecting whether to store the data transmitted at another timing after the timing in the first storage unit or store the data stored in the second storage unit in the first storage unit when the data is stored in the plurality of first storage units at the each timing.

2. The liquid discharging apparatus according to claim 1, further comprising a third storage unit that is used for storing the data that is transmitted at another timing prior to the timing,
wherein the data selecting unit selects whether to store the data transmitted at another timing after the timing in the first storage unit, store the data stored in the second storage unit in the first storage unit, or store the data stored in the third storage unit in the first storage unit.

3. The liquid discharging apparatus according to claim 1,
wherein the liquid discharging apparatus includes a plurality of the second storage units and a plurality of the data selecting units,
wherein the plurality of the second storage units is disposed in correspondence with the plurality of the first storage units, and
wherein the plurality of the data selecting units is disposed in correspondence with the plurality of the first storage units.

4. The liquid discharging apparatus according to claim 1, further comprising:
a first data selecting unit that is disposed as the data selecting unit in correspondence with a first nozzle;
a second data selecting unit that is disposed as the data selecting unit in correspondence with a second nozzle; and
a third data selecting unit that selects either first data that is the data transmitted to the first nozzle or second data that is the data transmitted to the second nozzle to be stored in the second storage unit,
wherein the plurality of nozzles includes the first nozzle and the second nozzle,
wherein, when the first data is stored in the second storage unit by the third data selecting unit, the first data selecting unit stores the first data stored in the second storage unit in the first storage unit, and the second data selecting unit stores the data transmitted at another timing after the timing in the first storage unit,
wherein, when the second data is stored in the second storage unit by the third data selecting unit, the first data selecting unit stores the data transmitted at another timing after the timing in the first storage unit, and the second data selecting unit stores the second data stored in the second storage unit in the first storage unit.

5. The liquid discharging apparatus according to claim 1, further comprising:
a main-side controller;
a carriage that is used for moving the plurality of nozzles; and
a cable that is used for transmitting the data from the main-side controller side to the carriage side,
wherein the second storage unit and the data selecting unit are disposed on the carriage side.

6. The liquid discharging apparatus according to claim 1, further comprising:
a main-side controller;
a carriage that is used for moving the plurality of nozzles; and
a cable that is used for transmitting the data from the main-side controller side to the carriage side,
wherein the second storage and the data selecting unit are disposed on the main-side controller side.

7. A method of discharging liquid droplets in which data for controlling discharge of liquid droplets from nozzles transmitted at each timing of a predetermined period is stored in a plurality of first storage units that is disposed for the nozzles, and the liquid droplets are discharged from the nozzles at the each timing based on the data stored in the plurality of first storage units, the method comprising:
storing the data transmitted at a timing in a second storage unit; and
selecting whether to store the data transmitted at another timing after the timing in the first storage unit or store the data stored in the second storage unit in the first storage unit when the data is stored in the plurality of first storage units at the each timing.
